(19) United States
(12) Patent Application Publication
(10) Pub. No.: US 2020/0392017 A1
(43) Pub. Date: Dec. 17, 2020

(54) SYSTEMS AND METHODS FOR WATER PURIFICATION

(71) Applicant: Qatar Foundation for Education, Science and Community Development, Doha (QA)

(72) Inventors: Ahmad Kayvani FARD, Doha (QA); Muataz; HUSSIEN, Doha (QA)

(21) Appl. No.: 16/772,559

(22) PCT Filed: Dec. 18, 2017
(86) PCT No.: PCT/QA2017/050005

§ 371 Date: Jun. 12, 2020

(51) Int. Cl. C02F 1/28; B01D 67/00; B01D 69/14; B01D 71/02

(52) U.S. Cl. CPC C02F 1/283; B01D 67/0041; B01D 69/147; C02F 2101/006; B01D 71/025; C02F 1/288; B01D 2325/28; B01D 71/021

(57) ABSTRACT

The present disclosure provides systems and methods for treatment of produced water that combine a separation technique using an inorganic membrane (Al₂O₃) with an adsorption process using activated carbon in the membrane. In one embodiment, a water tank includes an inlet and an outlet, and the membrane is in fluid communication with the inlet. The tank is configured to receive a spent water stream that includes a contaminant. In operation, the spent water stream is contacted with the membrane so as to strip at least a portion of the contaminant from the spent water stream.

### BACKGROUND

Production of oil and gas has increased exponentially due to economical and industrial growth across the globe. As a general rule, for producing one barrel of oil or gas, three barrels of so called “produced water” are also generated. The produced water generally contains different contaminants including hydrocarbons, heavy metals, free and emulsified oil, high salt content, radioactive materials, organics, etc. Although the produced water is heavily contaminated, it may become a source of water if treated and utilized efficiently.

Different processes are currently being used in industries for treatment of heavily contaminated produced water from oil/gas industries. Examples of such processes are a precipitation method, ion exchange treatment, reverse osmosis, filtration (ultra and micro), various flotation methods (dissolved air, column flotation, electro and induced air), adsorption, gravity separation, activated sludge treatment, membrane bioreactors, biological treatment, chemical coagulation, electro-coagulation, and coalescence. However, due to operational and economical limitations such as low efficiency, high operational and capital cost, generation of sludge, and inapplicability of certain techniques, such prior methods have not been widely accepted or used for the treatment of produced water.

As one example of the prior methods for treatment of produced water, the precipitation method generally generates large volumes of sludge, which may need to be dewatered and disposed. Ion-exchange on the other hand may require resins, which are synthetically produced using polymers and organics. Therefore, this operation when large volumes of contaminated water such as produced water are involved is typically quite costly and infeasible. Other problems such as metallic fouling by metals, fouling due to oil, grease, and organics, high operational cost, and reduction in efficiency due to the presence of acid are further drawbacks of ion exchange for produced water treatment. Polymeric membranes may be prone to fouling and scaling also due to high concentrations of contaminants such as organic and high salt content in the produced water. In addition, the lifetime of membranes may be shortened when acid media is used. Accordingly, it is desirable to provide an improved system and method for treatment of produced water from oil/gas industries.

### SUMMARY

Adsorption processes are widely used for removal of contaminants due to low cost, high efficiency, flexibility in design, and reusability. The present disclosure provides systems and methods for treatment of produced water that combine a separation technique using an inorganic membrane (Al₂O₃), with an adsorption process using activated carbon in the membrane. Although inorganic membranes are generally more expensive compared to polymeric membranes, inorganic membranes have advantages such as the ability to withstand harsh chemical cleaning and frequent backwashing, the ability to be sterilized and autoclaved, resistance to high temperature (up to 500° C.) and wear, the presence of well-defined and stable pore structure, high chemical stability, and a long life time.

In some embodiments, the system of the present disclosure includes a water tank comprising an inlet and an outlet, and a membrane in fluid communication with the inlet. The tank is configured to receive a spent water stream that includes a contaminant. The membrane includes alumina and activated carbon, and the membrane is configured to contact the spent water stream and strip at least a portion of the contaminant from the spent water stream.

The present disclosure also provides a method of purifying water, including providing a spent water stream that includes a contaminant, and contacting the spent water stream with a membrane so as to strip at least a portion of the contaminant from the spent water stream. In one embodiment, the membrane includes alumina and activated carbon.

In each or any of the above- or below-mentioned embodiments, the contaminant may include at least one selected from the group consisting of emulsified oil, barium, arsenic, lead, and strontium.

In each or any of the above- or below-mentioned embodiments, the membrane may strip the contaminant in entirety from the spent water stream.

In each or any of the above- or below-mentioned embodiments, the activated carbon may have an average particle size in the range of 0.025 mm to 0.18 mm.

In each or any of the above- or below-mentioned embodiments, the alumina may have an average particle size in the range of 0.1 μm to 10 μm.

In each or any of the above- or below-mentioned embodiments, the alumina may have an average particle size in the range of 0.1 μm to 5 μm.

In each or any of the above- or below-mentioned embodiments, the membrane may comprise 5% to 40% activated carbon by weight.

In each or any of the above- or below-mentioned embodiments, the membrane may comprise 10% to 30% activated carbon by weight.

In each or any of the above- or below-mentioned embodiments, a thickness of the membrane may be 0.5 mm to 20 mm.

In each or any of the above- or below-mentioned embodiments, the membrane may consist of alumina and activated carbon.

In each or any of the above- or below-mentioned embodiments, the membrane may be tubular and configured for an industrial scale water treatment.

It is accordingly an advantage of the present disclosure to provide systems and methods for water purification with increased rejection efficiency for contaminants.

Additional features and advantages are described herein, and will be apparent from the following Detailed Description and the figures.

### BRIEF DESCRIPTION OF THE FIGURES

Features and advantages of the systems and gas shut-off units described herein may be better understood by reference to the accompanying drawings in which:

FIG. 1 is a schematic illustration of a non-limiting embodiment of a system for water purification according to the present disclosure.

FIG. 2 is a flow chart of a non-limiting embodiment of a method of purifying water according to the present disclosure.

FIG. 3 shows optical images of an Al₂O₃ membrane (left) and an Al₂O₃/activated carbon (AC) hybrid membrane (right).

FIG. 4 schematically illustrates (a) Al₂O₃ and (b) Al₂O₃/AC hybrid membranes.

FIG. 5 shows SEM images of a surface of (a) Al₂O₃, (b,c) Al₂O₃/AC hybrid membranes and a cross section of (d) Al₂O₃ and (e,f) Al₂O₃/AC hybrid membranes.

FIG. 6 shows 2D Atomic Force Microscopy (AFM) image of (a) Al₂O₃ membrane and (b) Al₂O₃/AC hybrid membrane, and 3D AFM image of (c) Al₂O₃ membrane and (d) Al₂O₃/AC hybrid membrane, and pore size distribution of (e) Al₂O₃ membrane and (f) Al₂O₃/AC hybrid membrane.

FIG. 7 shows (a) X-ray diffraction (XRD) patterns of the as prepared membranes and, (b) Brunauer-Emmett-Teller (BET) surface area of the membranes, and (c) water contact of membranes.

FIG. 8 shows (a) pure water flux of as prepared membranes as function of different trans-membrane pressure, (b) oil content in the filtrate for various oil-in-water emulsions, (c) removal efficiency of membranes as function of oil concentration in the feed, (d) oil content in the filtrate for various salty oil-in-water emulsions (oil concentration: 2400 ppm), (e) removal efficiency of membranes as function of salt concentration in the oil-in-water emulsions (oil concentration: 2400 ppm), and (f) permeate flux of membrane for different feed emulsions.

FIG. 9 shows (a) the fouling ratios of Al₂O₃ and Al₂O₃/AC hybrid membranes, and (b) the removal efficiency of membranes at various cycles.

The reader will appreciate the foregoing details, as well as others, upon considering the following detailed description of certain non-limiting embodiments of systems and methods according to the present disclosure. The reader may also comprehend certain of such additional details upon using the systems and methods described herein.

### DETAILED DESCRIPTION

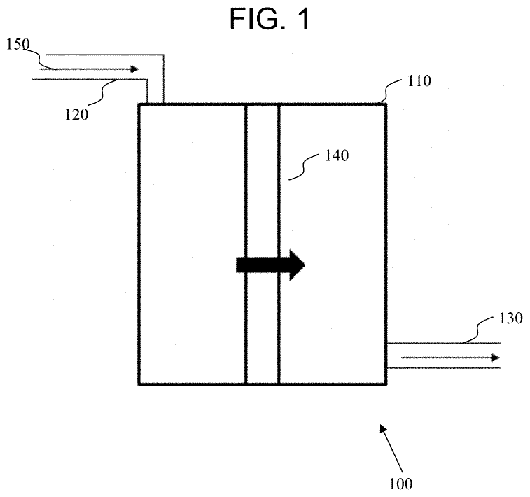

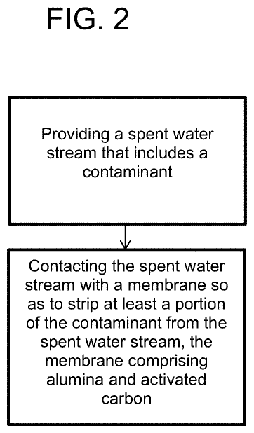

The present disclosure, in part, is directed to systems and methods for treatment of produced water that combine a separation technique using an inorganic membrane (Al₂O₃), with an adsorption process using activated carbon in the membrane. Referring to FIG. 1, the system 100 of the present disclosure includes a water tank 110 comprising an inlet 120 and an outlet 130, and a membrane 140 in fluid communication with the inlet 120. The tank 110 is configured to receive a spent water stream 150 that includes a contaminant. With continuing reference to FIG. 2, in operation the spent water stream 150 is contacted with the membrane 140 so as to strip at least a portion of the contaminant from the spent water stream 150.

According to certain non-limiting embodiments, the membrane 140 may include 5% to 40% activated carbon by weight. In some embodiments, the activated carbon content in the membrane 140 may be at least 5%, at least 10%, at least 15%, at least 20%, at least 25%, at least 30%, or at least 35%. In further embodiments, the activated carbon content in the membrane 140 may be no greater than 40%, no greater than 35%, no greater than 30%, no greater than 25%, no greater than 20%, no greater than 15%, or no greater than 10%. As such, the activated carbon content in the membrane 140 may be in the range of 10% to 30% by weight, 10% to 25% by weight, or 10% to 20% by weight. Depending on the usage requirements or preferences for the particular membrane, an activate content of less than about 5% may not provide the requisite adsorption efficiency for contaminants.

According to certain non-limiting embodiments, the membrane 140 may include activated carbon having an average particle size in the range of 0.025 mm (U.S. sieve size 500 mesh) to 0.18 mm (U.S. sieve size 80 mesh). In some embodiments, the activated carbon may have an average particle size of at least 0.025 mm (U.S. sieve size 500 mesh), at least 0.037 mm (U.S. sieve size 400 mesh), at least 0.044 mm (U.S. sieve size 325 mesh), at least 0.053 mm (U.S. sieve size 270 mesh), at least 0.063 mm (U.S. sieve size 230 mesh), at least 0.075 mm (U.S. sieve size 200 mesh), at least 0.090 mm (U.S. sieve size 170 mesh), at least 0.105 mm (U.S. sieve size 140 mesh), at least 0.12 mm (U.S. sieve size 120 mesh), or at least 0.150 mm (U.S. sieve size 100 mesh). In further embodiments, the membrane 140 may include activated carbon having an average particle size of no greater than 0.180 mm (U.S. sieve size 80 mesh), no greater than 0.150 mm (U.S. sieve size 100 mesh), no greater than 0.125 mm (U.S. sieve size 120 mesh), no greater than 0.105 mm (U.S. sieve size 140 mesh), no greater than 0.090 mm (U.S. sieve size 170 mesh), no greater than 0.075 mm (U.S. sieve size 200 mesh), no greater than 0.063 mm (U.S. sieve size 230 mesh), no greater than 0.053 mm (U.S. sieve size 270 mesh), no greater than 0.044 mm (U.S. sieve size 325 mesh), or no greater than 0.037 mm (U.S. sieve size 400 mesh). As such, the activated carbon may have an average particle size in the range of 0.105 mm (U.S. sieve size 150 mesh) to 0.180 mm (U.S. sieve size 80 mesh), 0.125 mm (U.S. sieve size 120 mesh) to 0.180 mm (U.S. sieve size 80 mesh), or 0.150 mm (U.S. sieve size 100 mesh) to 0.180 mm (U.S. sieve size 80 mesh). Depending on the usage requirements or preferences for the particular membrane, activated carbon with an average particle size of less than about 0.025 mm (U.S. sieve size 500 mesh) may not provide the requisite adsorption efficiency for contaminants.

According to certain non-limiting embodiments, the membrane 140 may include alumina having an average particle size in the range of 0.1 μm to 10 μm. In some embodiments, the alumina may have an average particle size of at least 0.1 μm, at least 0.2 μm, at least 0.3 μm, at least 0.4 μm, at least 0.5 μm, at least 0.6 μm, at least 0.7 μm, at least 0.8 μm, at least 0.9 μm, at least 1 μm, at least 2 μm at least 3 μm, at least 4 μm, at least 5 μm, at least 6 μm, at least 7 μm, at least 8 μm, or at least 9 μm. In further embodiments, the membrane 140 may include alumina having an average particle size of no greater than 10 μm, no greater than 9 μm, no greater than 8 μm, no greater than 7 μm, no greater than 6 μm, no greater than 5 μm, no greater than 4 μm, no greater than 3 μm, no greater than 2 μm, no greater than 1 μm, no greater than 0.9 μm, no greater than 0.8 μm, no greater than 0.7 μm, no greater than 0.6 μm, no greater than 0.5 μm, no greater than 0.4 μm, no greater than 0.3 μm, or no greater than 0.2 μm. As such, the alumina may have an average particle size in the range of 0.1 μm to 5 μm, 0.1 μm to 1 μm, or 0.1 μm to 0.3 μm. Depending on the usage requirements or preferences for the particular membrane, alumina with an average particle size of greater than about 10 μm may not provide the requisite filtration efficiency for contaminants.

According to certain non-limiting embodiments, the membrane 140 may have a thickness in the range of 0.5 mm to 20 mm. In some embodiments, the thickness of the membrane 140 may be at least 0.5 mm, at least 1 mm, at least 1.5 mm, at least 2 mm, at least 3 mm, at least 4 mm, at least 5 mm, at least 10 mm, or at least 15 mm. In further embodiments, the thickness of the membrane 140 may be no greater than 20 mm, no greater than 15 mm, no greater than 10 mm, no greater than 5 mm, no greater than 4 mm, no greater than 3 mm, no greater than 2 mm, no greater than 1.5 mm, or no greater than 1 mm. As such, the thickness of the membrane 140 may be in the range of 0.5 mm to 10 mm, 0.5 mm to 2 mm, or 1 mm to 2 mm. Depending on the usage requirements or preferences for the particular membrane, membranes with a thickness of greater than about 20 mm may not provide the requisite rejection efficiency for contaminants. According to certain non-limiting embodiments, the membrane 140 may be tubular and configured for an industrial scale water treatment.

The present inventors have surprisingly discovered that the system 100 according to the present disclosure including the membrane 140 including alumina and activated carbon advantageously increased rejection efficiency for contaminants in produced water. According to certain non-limiting embodiments, the contaminants may include at least one selected from the group consisting of emulsified oil, barium, arsenic, lead, and strontium. In some embodiments, the membrane 140 may strip the contaminants so as to maintain the contaminants contents within about 2.00% or less, 1.00% or less, 0.900% or less, 0.800% or less, 0.700% or less, 0.600% or less, 0.500% or less, 0.400% or less, 0.300% or less, 0.200% or less, 0.100% or less, 0.090% or less, about 0.080% or less, about 0.070% or less, about 0.060% or less, about 0.050% or less, about 0.040% or less, about 0.030% or less, about 0.020% or less, about 0.010% or less, about 0.009% or less, about 0.008% or less, about 0.007% or less, or about 0.006% or less. In further embodiments, the membrane 140 may strip the contaminant in entirety from the spent water stream 150.

The following is a non-limiting example of a system 100 according to the present disclosure. This particular example does not encompass all possible options for the activated carbon content and average particle sizes. Rather, the present inventors determined that the activated carbon content and average particle sizes given in this example represent possible average particle sizes that can produce embodiments of the membrane. It is to be understood that the systems and methods of the present disclosure may incorporate other suitable activated carbon and average particle sizes.

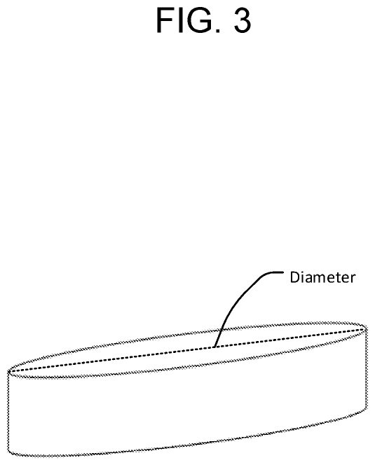

The hybrid separator-sorbent membrane was prepared using simple mixing-casting-sintering method. Briefly, 90 g of AKP-30 Al₂O₃ powder (Sumitomo Chemical Company Ltd., Japan) with an average particle size of approximately 0.27 μm was mixed with 35 ml of 0.02 M HNO₃ (Sigma-Aldrich Co.) and gently stirred until a uniform slurry was prepared. 10 g of activated carbon (Sigma-Aldrich Co.) with 100-mesh average particle size was then added to the slurry and stirred until a uniform grey slurry was prepared. The slurry was then transferred to a crucible formed out of polytetrafluoroethylene (PTFE), and ball milled for 4 min at 280 rpm in presence of Al₂O₃ balls. The gel was then transferred to the vacuum chamber for 5 min to remove any air/gas in the solution. After degassing, the solution was transferred to the disc cast to produce a 1.5 mm thick green membrane. The membrane was kept overnight to dry and then sintered at 1150° C. under vacuum and 100 ml/min argon flow. The membrane was then cut to a 25 mm diameter disc and polished as shown in FIG. 3.

Surfactant-stabilized oil emulsions were prepared by mixing DI water and Hexadecane (Sigma-Aldrich Co.) in different concentrations. Depending on the amount of Hexadecane, sodium dodecyl sulfate in 1:10 wt. ratio was added to the solution as surfactant under sonication for 60 mins. Normally, the prepared emulsions are stable for more than 7 days without de-emulsification or precipitation when placed in room environment. To prepare saline emulsions, NaCl (Sigma-Aldrich Co.) at different concentrations were added to the emulsion and stirred for 4 h to dissolve the salt.

Scanning electron microscopy (SEM) was performed using a Field-emission gun scanning electron microscopy (FEG-SEM) with a Nova NanoSEM 650 (FEI corp.). XRD patterns of the membranes were recorded on a polycrystalline X-ray diffractometer with a Cu Karadiation source (Bruker D8 Advance, Bruker-AXS, Germany). Membrane Contact angles were measured by a contact angle measurement machine (Rame-hart A100, USA). Membrane topography and roughness was analyzed by atomic force microscopy (AFM) (Dimension FastScan, Brucker, Germany) in tapping mode. The surface areas of membranes were measured by N₂ adsorption at 77 K using a BET surface area analyzer (Micromeritics ASAP 2020, USA). The zeta potential of membrane and oil emulsion is analyzed using Dynamic Light Scattering (DLS) method (Nanotrac Wave II, Microtrac, USA). The oil concentration in the feed and permeate was measured by the combustion type TOC analyzer (Shimadzu, model TOC-L, Japan).

The as-prepared Al₂O₃/AC membrane was fixed into the membrane filter cell (Sartorius, model SM17530, Germany) with active membrane area of 19.63 cm². The cell was then connected to the pressure vessel (reservoir) and kept under nitrogen pressure to ensure constant pressure filtration conditions. The flux data was measured and recorded using electronic balance linked to a PC-based data acquisition system.

The flux of the membrane was calculated using gravimetric method with a digital electronic balance by weighing the permeate using equation 1:

$$J = \frac{W \text{?}}{A \text{?}} \\ \text{?} \text{indicates text missing or illegible when filed} \qquad ( 1 )$$

Where J is the permeate flux, Wₚ is the weight of permeate (g), ρ is the density of water, A is the effective membrane area (m²) and t is the filtration time (h).

The separation efficiency of the membranes were calculated based on concentrations of the oil in the feed and permeate solutions, according to the equation (2):

$$Seperation efficiency ( \% ) = \frac{\text{?} - \text{?}}{C \text{?}} \times 100 \\ \text{?} \text{indicates text missing or illegible when filed} \qquad ( 2 )$$

where C_{f} represents the concentration of oil in the permeate solution and Cᵢ is the concentration of oil in the feed solution.

Porosity of the membranes were calculated using Archimedes' principle, in which the membranes are dried in oven at 115° C. for 24 h to remove all moisture content and the dry weight (W_{d}) was recorded. The membranes were then immersed in DI water for 48 h and taken out. Water on outer surface was carefully wiped off using tissue paper and the wet weight of the membranes (W_{w}) was recorded. The porosity of the membrane was then calculated as per equation (3):

$$\text{?} ( \% ) = \frac{W \text{?} - W \text{?}}{W \text{?}} \times 100 \\ \text{?} \text{indicates text missing or illegible when filed} \qquad ( 3 )$$

To evaluate the permeability loss due to the fouling, fouling ratio was used and calculated as per equation (4):

$$Fouling ratio ( \% ) = ( 1 - \frac{\text{?} - \text{?}}{\text{?}} ) \times 100 \\ \text{?} \text{indicates text missing or illegible when filed} \qquad ( 4 )$$

where J_{DI water} is pure water and J_{oil-water emulsion} is the water flux of oil-water emulsion as feed solution.

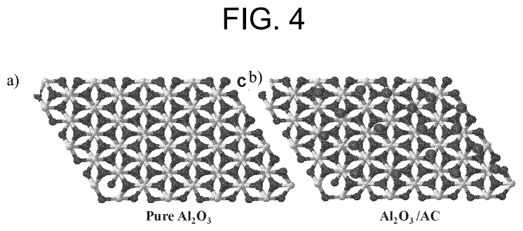

The membranes showed very good mechanical and chemical robustness and used directly in the filtration experiment without any further treatment or modification. As illustrated in FIG. 4, incorporating AC in the alumina matrix resulted in a porous structure in the membrane matrix which is used as a path for water to pass through the membrane. Introduction of AC in the Al₂O₃ matrix formed micro-channels in the Al₂O₃ hybrid membrane which in addition to the enhancing water passage, increased the filtration and adsorption efficiency. The micro-channels had relatively smaller diameter compared to the pores created by Al₂O₃ matrix which also enhanced the filtration of smaller size contaminants. Emulsified oil, due to their very tiny droplet size, was better rejected/adsorbed by Al₂O₃/AC hybrid due to presence of such micro-channels. Another advantage of hybridization was shorter filtration time. Due to passage of water using shortcuts created by micro-channels in AC, filtration time was enhanced which resulted in improved filtration performance. Due to their small particle size close to the alumina particle size, incorporation of AC in the Al₂O₃ matrix did not cause any mechanical disadvantages such as formation of cracks.

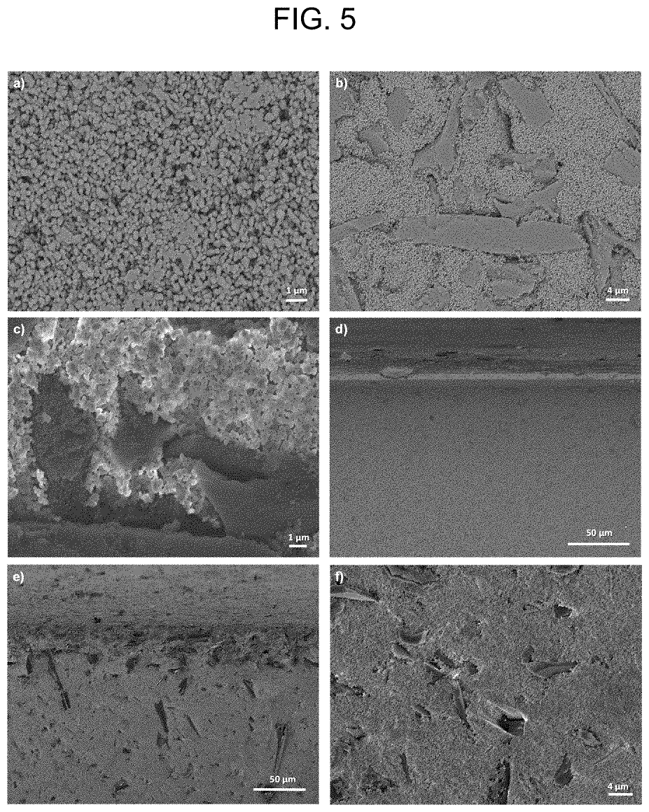

Scanning Electron Microscopy (SEM) of surface and cross section of Al₂O₃ membrane and Al₂O₃/AC hybrid membrane are presented in FIG. 5. FIG. 5a shows the surface morphology of Al₂O₃ membrane with dense structure and sponge-like structure. On the other hand, FIG. 5b,c show the surface of Al₂O₃/AC hybrid membrane with AC particles scattered across the membrane surface keeping the sponge-like structure of the Al₂O₃ matrix. AC was created a uniform porous microstructure with glassy and flaky structure on the surface of the membrane. As seen in FIG. 5c, introduction of AC in the Al₂O₃ matrix, exhibited more porous and less dense structure for the membrane. Comparing the cross section of Al₂O₃ membrane (FIG. 5d) with cross section of hybrid membrane (FIG. 5e,f), it can be seen that introduction of AC in the matrix had no adverse mechanical impact yet leading to homogeneous, smooth and crack-free morphology. Also, from FIG. 5d and FIG. 5e, the membrane represented as symmetric structure with one thick dense layer mainly originated from the Al₂O₃ composition. The SEM images of hybrid membrane also showed that random distribution of AC across the Al₂O₃ matrix did not lead to defect or delamination between Al₂O₃3 particles. A superficial observation from SEM image in FIG. 5a and FIG. 5c, indicated that the maximum observable pore size of the membrane's surface were less than 0.5 μm and 0.25 μm for Al₂O₃ and Al₂O₃/AC hybrid membrane. Moreover, introduction of AC particles did not alter the size and shape of Al₂O₃ particle, suggesting that the membrane was free of agglomeration.

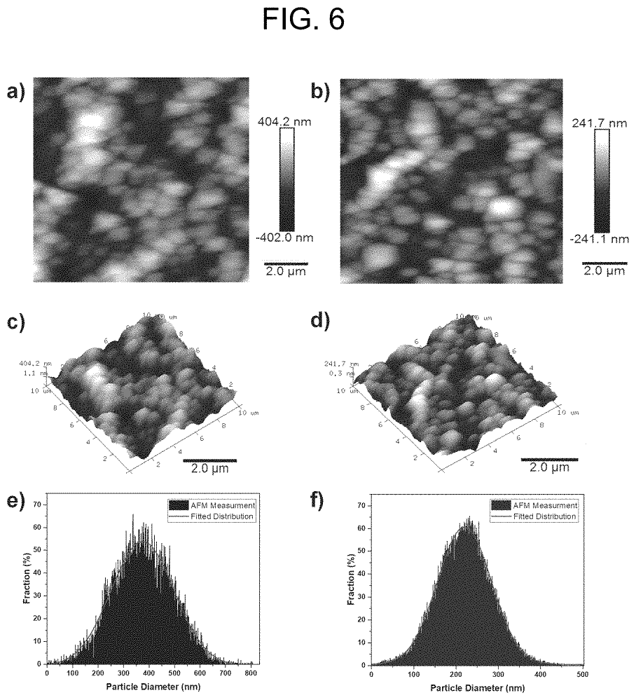

To compare the surface roughness and also the pore size distribution, Atomic Force Microscopy (AFM) was employed to analyze the surface of two membranes. Introduction of AC into the Al₂O₃ matrix further refined the structure of membrane by reducing the topography roughness (Ra) of the membrane by 5 folds from 95 nm to less than 17.7 nm. The AFM Images in FIG. 6a-d showed that the maximum feature heights (Rₘₐₓ) of Al₂O₃ membrane was about 405 nm while the same for the hybrid membrane was less than 139 nm. The smoother surface of hybrid membrane was consistent with the superficial observation from SEM image and was as expected. While not wishing to be bound by theory, it is believed that introduction of AC particles into the matrix filled the valleys between the Al₂O₃ particles features, resulting in smoother surface and less feature height. The AFM pore size distribution analysis of two membranes are illustrated in FIG. 6e,f. A well-defined peak for both membranes can be observed with majority of pores being in the range of 350 nm and 220 nm for Al₂O₃ and Al₂O₃/AC hybrid membrane, respectively. The hybrid membrane showed a narrower pore diameter compared to the Al₂O₃ membrane, due to excellent dispersion of AC into the matrix. In case of water filtration, narrower pore size distribution may be favorable as it results in improved selectivity of membrane. Generally, by increasing the pore size, the permeate flux should increase. Surprisingly, in case of a hybrid membrane, although the pore diameter are smaller compared to pure Al₂O₃ membrane, the permeate flux was higher. While not wishing to be bound by theory, it is believed that this can be related to the micro-channels introduced earlier, where these channels accelerate the water flow and hence higher flux and less filtration time.

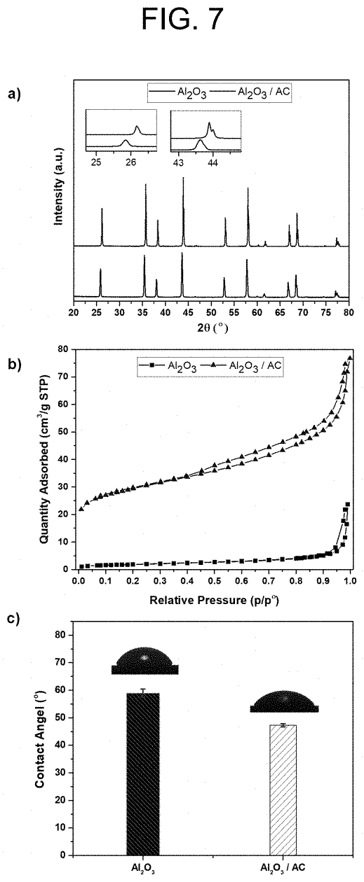

To confirm the phase composition of membranes, X-ray diffraction (XRD) experiment was carried out. FIG. 7a illustrates the phase purity of α-Al₂O₃ and Al₂O₃ hybrid membrane with very sharp diffraction peaks. All the typical peaks of α-Al₂O₃ were detected by the XRD profile indicating no significant chemical reaction between Al₂O₃ and AC. The diffraction peaks of carbon which matches the JCPDS are reported at 20 of 24° and 43.2° can be also seen in the diffraction peak of Al₂O₃/AC hybrid membrane. As it can be seen from inset of FIG. 7a, the peak at 20 of 24° which corresponds to graphite (002) plane was shifted to a higher angle with higher intensity due to the stress in the crystal lattice caused during sintering process. This type of peak is indication of non-uniform but permanent stress on the crystal lattice. Both Al₂O₃ and carbon have diffraction peaks at 20 of 24°. The peak of the Al₂O₃/AC membrane had a higher intensity as both Al₂O₃ and carbon peak merged together, resulting in a more intense peak. The peak at 20 of 43.2° corresponding to graphite (100) plane had also shifted to the higher angle but shouldered due to non-permanent stress on the crystal lattice. The XRD peaks of α-Al₂O₃ at 20 were 26°, 35°, 37°, 44°, 53.5, 57, 62, 67, and 75°; these were the signature peaks of α-Al₂O₃ in which they correspond to 012, 104, 110, 113, 024, 116, 018, 214, and 119 lattice plane.

The analysis results of the nitrogen (N₂) adsorption-desorption isotherms of the Al₂O₃ and Al₂O₃/AC membranes are presented in FIG. 7b. The Al₂O₃/AC showed an apparently enhanced adsorption-desorption intensity compared to the pure Al₂O₃ membrane. The Brunauer-Emmett-Teller (BET) specific surface areas (SSA) of the Al₂O₃ and Al₂O₃/AC hybrid membrane calculated from the isotherms were 6.5 m²/g and 99.2 m²/g, respectively. The higher SSA of the hybrid membrane was due to incorporation of AC in the membrane matrix. The SSA of AC powder was about 1278 m²/g, while that of Al₂O₃ powder was 10.5 m²/g. During sintering and mixing, some of the AC pores were clogged and therefore the surface area of Al₂O₃/AC membrane was reduced compared to the powder SSA. However, due to good dispersion and random distribution of AC in the Al₂O₃ matrix, the SSA of the hybrid membrane was 16 times higher than that of pure Al₂O₃ membrane. The adsorption isotherms in FIG. 7b were almost similar to each other and can be considered as type IV with hysteresis loops according to the relative pressures (P/Pₒ) being between 0.4 and 1.0. On the other hand, both isotherms were very smooth until P/Pₒ=0.5 with a rapid and sharp increase in the adsorption of nitrogen after P/Pₒ=0.5 which can be explained as membranes are being both mesoporous and macroporous. At the first stage, most of the micropores are filled with N₂. These micropores are mainly formed due to incorporation of AC. Next, due to nature of the random packing of the Al₂O₃ particle after sintering and also built-up of random Al₂O₃ particles which then form aggregates in the membrane, N₂ gas is adsorbed by the mesopores forming type IV hysteresis isotherm. Presences of both micro and mesopores are confirmed earlier by the pore size distribution analysis in FIG. 6e,f.

An efficient membrane to separate oil from water preferably exhibits either water superhydrophilicity or superoleophobicity. The wetting behavior of the membranes was evaluated using contact angle analysis and the behavior of water contact angle of as prepared membranes is shown in FIG. 7c. The Al₂O₃/AC membrane showed superhydrophilicity with contact angle of 47.3±1.2°, whereas the water contact angle of pure Al₂O₃ membrane was close to 59±2.3°. When oily wastewater is being filtered, the water gets through the membrane pores and trapped into the rough structure due to presence of oxides which can cause high surface energy and therefore lead to less contact angle when oil passes through the membrane. This was in good agreement with the surface roughness calculated using AFM analysis. Generally contact angle increases with increasing mean surface roughness. This was the case in the prepared membrane, as the Al₂O₃/AC hybrid membrane which exhibited smoother surface compared to pure Al₂o₃ membrane had a lower water contact angle.

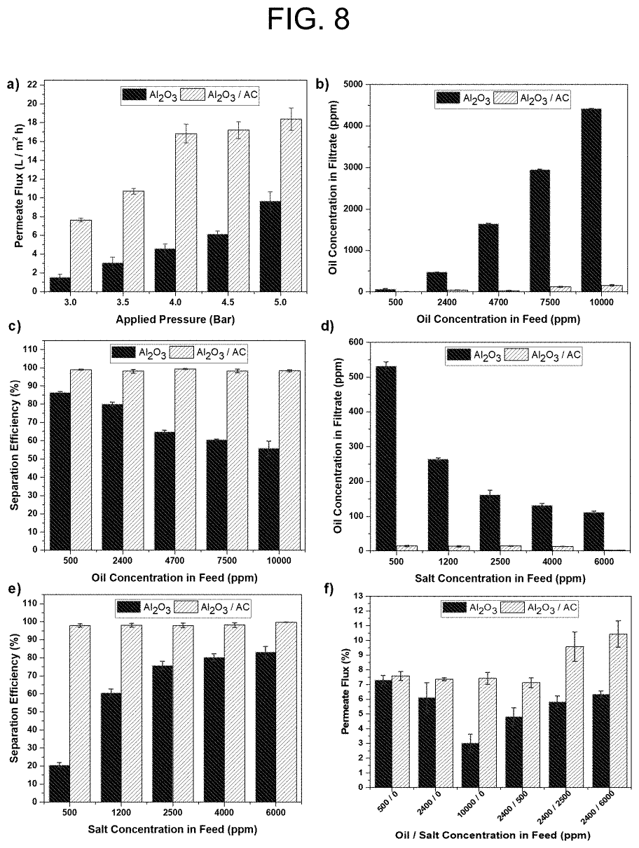

Different oil-in-water nanoemulsions were prepared as the feed for examining membrane separation efficiency. It was found by the inventors that different factors such as oil concentration, surfactants and salt concentration in the feed play a crucial role in the dispersion of oil droplets in emulsion and hence in permeate water quality. FIG. 8a-f demonstrates the effect of these parameters on permeate flux, separation efficiency, and permeate water quality.

In order to assess the effect of incorporating AC into Al₂O₃ matrix, water permeability of the pure Al₂O₃ membrane and Al₂O₃/AC hybrid membrane were compared using DI water. As illustrated in FIG. 8a, the pure water flux (permeability) increased by increasing applied transmembrane pressure (TMP) due to an increase in the driving force across the membrane. The permeate flux of the membrane was almost double in the hybrid membrane compared to the pure Al₂O₃ membrane. The values of the flux are typical for UF membrane. The results indicate that incorporation of AC in the matrix is responsible for higher flux as formation of micro- and nano-channels in the membrane enhanced the permeability of the membrane. From membrane porosity point of view, the porosity of membrane calculated using Archimedes' principle was found to be 15.5% and 27% for Al₂O₃ and Al₂O₃/AC hybrid membrane, respectively. The hybrid membrane due to the micro-channels formed by incorporation of AC had the porosity almost doubled compared to the pure Al₂O₃ membrane. Therefore, the membrane with higher porosity had a higher flux.

Effect of different oil concentration in the feed on permeate water quality and separation efficiency of both membranes are illustrated in FIG. 8b,c. As shown in FIG. 8b,c, as the oil concentration increased, the percent oil rejection for Al₂O₃/AC hybrid membrane increased slightly, close to 100% (or remained as is without any changes). As the oil content increased, the oil droplets adsorbed/retained by membrane decreased. Also, at higher oil concentration, oil droplets were larger in size compared to the lower concentration. Therefore, penetration of oil particles larger than the pore size of the membrane was unlikely. Due to the combination of these two facts and the surface properties of the membrane, as oil content in the feed increased, the oil content in the permeate decreased, which led to higher separation efficiency. Moreover, although increasing the oil concentration in the membrane boundary layer reduced the flux and separation efficiency in the pure Al₂O₃ membranes, the high hydrophilicity in the Al₂O₃/AC membrane caused invasion of water phase which allowed water to pass but rejected oil droplets. The decline in separation efficiency and increase oil content in the filtrate for Al₂O₃ membrane reveals that the membrane was more prone to fouling by oil droplets.

The presence of salt in the oil-water emulsion can be a critical factor affecting the performance of the membrane. Globally, the largest source of oily wastewater is also saline which is known as produced-water. Presence of salt in oil-water emulsion changes the characteristic of the emulsion by altering the stability of oil in the water. When salts presents in the emulsion, the ion concentration in the solution changes. The high ion concentration causes weakening the emulsion through reduction in hydration of the surfactant which as consequence, make the emulsion unstable. Therefore, as seen in FIG. 8d,e, the feed with higher salt (ion) concentration, had lower oil concentration in the permeate and higher separation efficiency. This effect was even higher for Al₂O₃/AC hybrid compared to the pure Al₂O₃ membrane due to smaller and narrower pore size distribution. The rejection efficiency of membrane was enhanced by approximately four folds in Al₂O₃ membrane from 20% to approximately 80% when the salt concentration was raised from 500 ppm to 6000 ppm. However, the effect of salt on the performance of the hybrid membrane was minimal as the membrane was robust and effectively rejected the oil at different concentration by close to 100%. Also, the presence of AC helped the adsorption of tiny oil droplets through an adsorption process.

As shown in FIG. 8f, the permeate flux also increased as the salt content increased. Generally, increasing flux by increasing salt content in the oil-water emulsion can be related to two factors: 1) density of emulsion and 2) membrane-oil/water interfacial interaction. As the salt concentration increases, the density of the feed increases. Therefore, this can cause a difference between the continuous phase and the dispersed oil/water phase. In fact, the oil droplets can move toward the membrane surface. On the other hand, as the membrane surface is hydrophilic, the oil droplets may be rejected and more water may pass through the membrane. The second factor relates to the charge on the surface of membrane and oil/water emulsion. As salt content increases, the zeta potential of the solution changes toward being more positive. However, the zeta potential of Al₂O₃ and Al₂O₃/AC hybrid membrane were −15 mV and −25 mV respectively. Here, the presence of salts in the emulsions caused the permeate flux to increase due to increase in the repulsion between oil droplets and membrane surface. The repulsion was higher in the Al₂O₃/AC membrane as its surface has higher negative charge compared to the pure Al₂O₃ membrane. Notably, the hybrid membrane had the permeate flux almost doubled from 6 to almost 12 kg/m2 h. However, the change in the flux by increasing salt resulted in no major permeate quality decline for the Al₂O₃/AC membrane as shown in FIG. 8d. While not wishing to be bound by theory, it is believed that this is directly related to the surface chemistry and structure of the membrane. Generally, this can be correlated to the retention of Na and Cl ions from the surface of membrane. When ions are retained on the surface of membrane causing blockage on the pores, water molecules are obstructed to pass by the pores and therefore reducing the flux and consequently causing fouling on the surface of membrane. On the other hand, it is believed that the AC in the membrane matrix rejects the hydrated Na⁺ and Cl⁻ ions. In addition, due to smother surface of Al₂O₃/AC membrane, their ability to retain ions would be lower. Thus, concentration of ions and oil droplets on the surface of Al₂O₃/AC hybrid membrane was less compared to the pure membrane, resulting in higher flux and hence less fouling.

One more fact which can be concluded from FIG. 8f is the reduction of permeate flux by increasing oil concentration. FIG. 8f indicates that for Al₂O₃ membrane, as oil concentration increased, permeate flux decreased. This can be correlated to the increase in the resistance to the flux which is resulted by development of thick oil layer on the surface of membrane at elevated oil concentration in the feed. The oil layer on the surface enhances the adsorptive resistance and concentration polarization resistance on the membrane, and hence reduction in permeate flux. This effect is minimal in the Al₂O₃/AC membrane as presence of carbon causes to reject the hydrated oil or ions and hence minimize the formation of oil boundary layer on the surface of the membrane. Moreover, as the oil content increases, the oil droplets size also increases which leads to blockage of the membrane pores due to the existence of size distribution of membrane pores. Also, the effect of concentration polarization on the membrane due to increase in the oil content of retentate is another possible reasons for decline in the flux for pure Al₂O₃ membrane. This effect is negligible in the Al₂O₃/AC membrane as the surface of the hybrid membrane is more oilephobic compared to the pure membrane as discussed earlier.

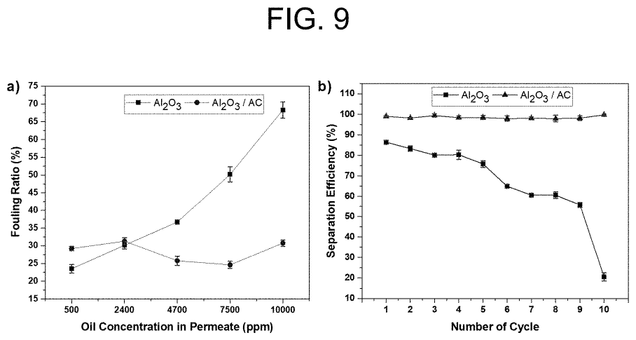

The fouling performances of the membranes were analyzed using fouling ratio and their separation efficiency was evaluated for 10 cycles as shown in FIG. 9a,b. After each cycle the membrane was washed with ethanol and the separation efficiency of both membranes were studied systematically for oil filtration. FIG. 9a shows that the Al₂O₃ was more prone to fouling compared to the hybrid membrane as the oil concentration increased. The antifouling property of Al₂O₃/AC hybrid membrane was much better as the fouling ratio remained in the range of 20-30% even at very high feed oil concentration. For instance, the fouling ratio of Al₂O₃ membrane was increased from 22% to about 67% along with increase of oil content from 500 ppm to 10000 ppm. On the other hand, for the same range of oil concertation, the fouling ratio of the Al₂O₃/AC hybrid membrane only slightly increased from 28% to approximately 29%. The reversible operation of membrane after cleaning with ethanol is shown in FIG. 9b. It can be seen that the Al₂O₃/AC hybrid membrane can be reused after 10 times without decline in its separation efficiency and capacity. The separation efficiency of the hybrid membrane was above 99% for each cycle without any notable decline. In contrast, the separation efficiency of the Al₂O₃ membrane was reduced from 89% to less than 20% after 10 cycles. While not wishing to be bound by theory, it is believed that the antifouling property of Al₂O₃/AC membrane contrary to the pure Al₂O₃ membrane is related to the incorporation of AC in the Al₂O₃ matrix which alters the surface properties of the membrane.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the disclosure so claimed are inherently or expressly described and enabled herein.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A system for water purification, the system comprising:
a water tank comprising an inlet and an outlet, the tank configured to receive a spent water stream that includes a contaminant; and
a membrane in fluid communication with the inlet, the membrane comprising alumina and activated carbon, and the membrane configured to contact the spent water stream and strip at least a portion of the contaminant from the spent water stream.

2. The system of claim 1, wherein the contaminant includes at least one selected from the group consisting of emulsified oil, barium, arsenic, lead, and strontium.

3. The system of claim 1, wherein the membrane strips the contaminant in entirety from the spent water stream.

4. The system of claim 1, wherein the activated carbon has an average particle size in the range of 0.025 mm to 0.18 mm.

5. The system of claim 1, wherein the alumina has an average particle size in the range of 0.1 μm to 10 μm.

6. The system of claim 1, wherein the alumina has an average particle size in the range of 0.1 μm to 5 μm.

7. The system of claim 1, wherein the membrane comprises 5% to 40% activated carbon by weight.

8. The system of claim 1, wherein the membrane comprises 10% to 30% activated carbon by weight.

9. The system of claim 1, wherein a thickness of the membrane is 0.5 mm to 20 mm.

10. The system of claim 1, wherein the membrane consists of alumina and activated carbon.

11. The system of claim 1, wherein the membrane is tubular and configured for an industrial scale water treatment.

12. A method of purifying water, the method comprising:
providing a spent water stream that includes a contaminant; and
contacting the spent water stream with a membrane so as to strip at least a portion of the contaminant from the spent water stream, the membrane comprising alumina and activated carbon.

13. The method of claim 12, wherein the contaminant includes at least one selected from the group consisting of emulsified oil, barium, arsenic, lead, and strontium.

14. The method of claim 12, wherein the membrane strips the contaminant in entirety from the spent water stream.

15. The method of claim 12, wherein the activated carbon has an average particle size in the range of 0.025 mm to 0.18 mm.

16. The method of claim 12, wherein the alumina has an average particle size in the range of 0.1 ∞m to 10 μm.

17. The method of claim 12, wherein the alumina has an average particle size in the range of 0.1 μm to 5 μm.

18. The method of claim 12, wherein the membrane comprises 5% to 40% activated carbon by weight.

19. The method of claim 12, wherein the membrane comprises 10% to 30% activated carbon by weight.

20. (canceled)

21. The method of claim 12, wherein the membrane consists of alumina and activated carbon.

22. (canceled)
